(19) United States
(12) Patent Application Publication
(10) Pub. No.: US 2010/0014082 A1
(43) Pub. Date: Jan. 21, 2010

(54) ANGLE LIMITING REFLECTOR AND OPTICAL DISPERSIVE DEVICE INCLUDING THE SAME

(75) Inventor: Eberhard Loecklin, Reutlingen (DE)

Correspondence Address: Pequignot + Myers LLC, 140 Marine View Avenue, Suite 220, Solana Beach, CA, 92075, US

(73) Assignees: Eberhard Loecklin, Reutlingen (DE); JDSU Deutschland GmbH, Eningen (DE)

(21) Appl. No.: 12/505,387

(22) Filed: Jul. 17, 2009

Related U.S. Application Data
(60) Provisional application No. 61/081,754, filed on Jul. 18, 2008.

(51) Int. Cl. G01J 3/28

(52) U.S. Cl. 356/328; 356/330

(57) ABSTRACT

The invention relates to angle-limiting optical reflectors and optical dispersive devices such as optical spectrum analyzers using the same. The reflector has two reflective surfaces arranged in a two-dimensional corner reflector configuration for reflecting incident light back with a shift, and includes two prisms having a gap therebetween that is tilted to reflect unwanted light and transmit wanted light. A two-pass optical spectrum analyzer utilizes the reflector to block unwanted multi-pass modes that may otherwise exist and degrade the wavelength selectivity of the device.

### CROSS-REFERENCE TO RELATED APPLICATIONS

The present invention claims priority from U.S. Provisional Patent Application No. 61/081,754 filed Jul. 18, 2008, entitled “Aperture Limiting Reflector”, which is incorporated herein by reference for all purposes.

### TECHNICAL FIELD

The present invention generally relates to a optical devices with angular disperison, and specifically relates to an optical spectrum analyzer utilizing angle limiting optical reflectors, and to angle limiting reflectors with compensation of the angular chromatic dispersion.

### BACKGROUND OF THE INVENTION

Optical spectrum analyzers (OSA's) are used for analyzing the output light beams from lasers, light emitting diodes (LED's) and other light sources. OSAs are particularly useful for analyzing light sources for optical telecommunication, where it is preferable to insure that the optical carrier includes only a single, spectrally pure wavelength. OSAs are also used for monitoring and analyzing information relating to WDM channels in an optical network, in which case they are some referred to as optical performance monitors.

In a typical OSA, the light intensity is displayed as a function of wavelength over a predetermined operating wavelength range. Parameters of importance in a typical OSA include the operating wavelength range and the spectral resolution, which is the ability of the OSA to distinguish between two different wavelengths in the analyzed light. One type of OSAs known in the art utilizes reflection dispersion gratings for dispersing input light at a plurality of angles in dependence on the wavelength. Spectral resolution of such grating-based OSAs typically depends on its size, with devices having a larger beam spot size upon the grating and longer travel paths of diffracted light prior to detection generally having better spectral selectivity.

Efficiency of the grating utilization in an OSA can be improved by utilizing a double-pass configuration, wherein the diffracted beam is returned back towards the grating, typically along a same optical path, for a second diffraction thereupon. Such devices employing double-pass or, generally, multi-pass configurations are disclosed, for example, in U.S. Pat. Nos. 4,995,721, 5,233,405, 7,006,765, 7,116,848, among others.

By way of example, FIG. 1 illustrates one prior art type of a double-pass OSA having a fixed detector 56 and a rotating grating 55 in a double-pass arrangement with a corner reflector 54, with a single lens between the reflector and the grating. This configuration, which is typical for devices used in laboratory environment, may allow for a wide spectral range, but still requires a relatively large distance between the corner reflector 54 and the grating 55e to incorporate the lens.

Nevertheless, prior art OSAs of compact size may still suffer from insufficient wavelength selectivity, especially if they operate in a broad wavelength range.

### SUMMARY OF THE INVENTION

An object of the present invention is to provide an optical dispersion device utilizing a dispersion grating in a multi-pass configuration, which can operate in a broad wavelength range with an improved spectral selectivity, while having a relatively compact size.

Another object of the present invention is to provide an angle limiting reflector for use in a multi-pass optical dispersion device.

Another object of the present invention is to provide a prism-based angle limiting reflector with compensation of angular chromatic dispersion.

In accordance with the invention, there is provided an optical dispersive device, comprising: a optical grating for receiving an input light beam along an input direction and for outputting at least a portion thereof as an output light beam in an output direction; and, a reflector optically coupled with the optical grating for operating in a double-pass configuration therewith, wherein light of a first wavelength diffracted from the grating at a first diffraction angle is reflected by the reflector back towards the optical grating for diffracting thereupon in an output direction for forming the output beam. The reflector has first and second reflecting surfaces for forming a two-dimensional corner reflector, and comprises first and second prisms of an optically transmissive material sequentially positioned with a gap therebetween in an optical path of the light diffracted from the grating, wherein at least the first prism is wedged-shaped having a light output face slanted with respect to a light input face at a first vertex angle, and wherein the light output face thereof is slanted at a second angle with respect to the dispersion plane.

The second angle and the first vertex angle of the first prism are selected so that the light diffracted from the grating at the first diffraction angle is transmitted through the first prism into the second prism, while light that is diffracted from the grating at a second diffraction angle experiences a total internal refraction at the light output surface of the first prism, and is thereby deflecting away from the optical path.

In accordance with one feature of this invention, the second angle and the first vertex angle of the first prism are selected so that the total internal reflection at the output face of the first prism prevents light of any wavelength in the operating wavelength range from contributing into the output light beam after travelling more than twice between the reflecting grating and the reflector.

In accordance with another aspect of this invention, there is provided an angle limiting reflector for use in a multi-pass optical dispersive device, comprising:

first and second prisms of a light-transmissive material, disposed optically one after another in an optical path of an input light beam for receiving said light beam at an input face of a first prism at a first angle of incidence and for outputting the light beam through an output face of the second prism, wherein the two prisms are disposed with a gap between an output face of the first prism and an input face of the second prism;

wherein the output face of the first prism is slanted with respect to the input face thereof at a first angle that is selected to transmit rays within a desired range of angles of incidence and to deflect away undesired rays exceeding a pre-determined incidence angle by means of a total internal reflection, so as to impart a desired angular selectivity upon the retro-reflector;

wherein the gap has a wedge shape with a vertex angle selected to spatially separate light passing through the gap without reflections therein from light experiencing such reflections in the gap, and wherein the light beam acquires a first angular chromatic dispersion after propagating through the gap;

wherein the second prism has a first reflecting face that is oriented to direct the light beam impinging thereupon from an input face towards the output face thereof;

and wherein orientation of at least one of: the input face of the first prism, the output face of the second prism, and the reflecting face of the second prism with respect to an optical axis of the light beam is selected for imparting on the light beam, upon passing through the output surface of the second prism or the input surface of the first prism, a second angular chromatic dispersion that is opposite to the first chromatic dispersion for at least partial compensation thereof.

### BRIEF DESCRIPTION OF THE DRAWINGS

The invention will be described in greater detail with reference to the accompanying drawings which represent preferred embodiments thereof, wherein:

FIG. 1 is a diagram of a prior art double-pass OSA;

FIG. 2 is a schematic prospective view of an OSA with an angle limiting reflector according to one embodiments of the present invention;

FIG. 3 is a dispersion plane view of the OSA shown in FIG. 2 illustrating an optical path of a nominal double-pass mode;

FIG. 4 is a dispersion plane view of the OSA shown in FIG. 2 illustrating an optical path of a first four-pass mode;

FIG. 5 is a dispersion plane view of the OSA shown in FIG. 2 illustrating an optical path of a second four-pass mode;

FIG. 6 is a cross-sectional view of the angle limiting reflector of the OSA shown in FIGS. 2 to 5;

FIG. 7 is a diagram illustrating light propagation in the angle limiting reflector with a normal incidence at the input face;

FIG. 8 is a graph illustrating the selection of the gap orientation angle θ₂ for blocking light of an undesired multi-pass mode by TIR in dependence upon the dispersion plane angle of incidence for different tilts of the input face of the first prism;

FIG. 9 is a diagram illustrating light propagation in the angle limiting reflector with a tilted input face;

FIG. 10 is a graph illustrating the optimum incidence angle upon the output face of the second prism vs. the gap vertex angle ox for two orientations of the input face of the first prism;

FIG. 11 is a graph illustrating the optimum gap orientation angle θ₂ Vs. the gap vertex angle α for two orientations of the input face of the first prism;

FIG. 12 is a graph illustrating the angular dispersion of the output beam of the angle limiting reflector shown in FIG. 6 for four orientations of the reflective face of the second prism;

FIG. 13 is a diagram illustrating light propagation in another embodiment of the angle limiting reflector;

FIG. 14 is a diagram illustrating light propagation in an embodiment of the angle limiting reflector of the present invention including a pentaprism.

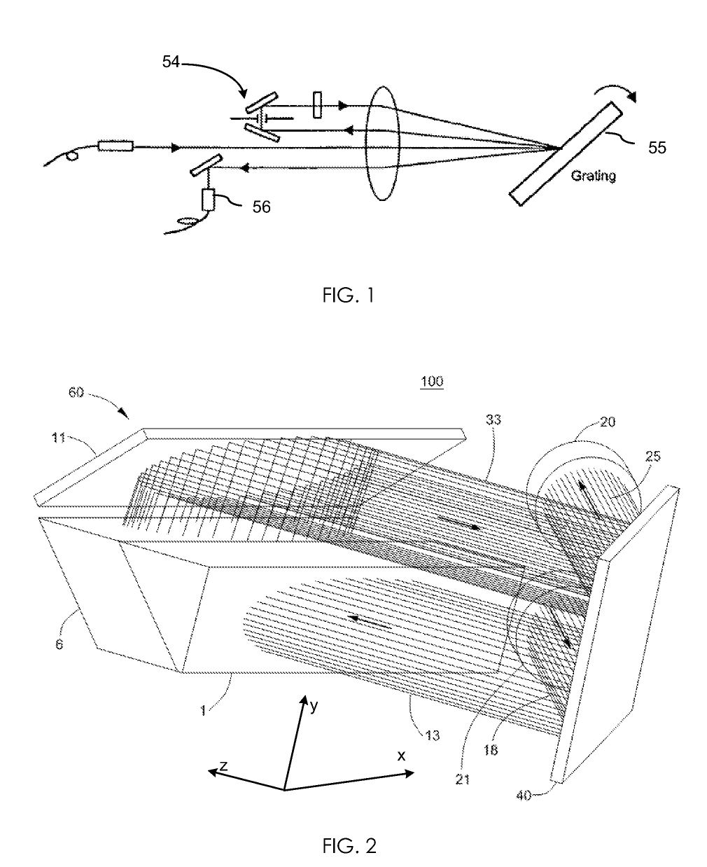

### DETAILED DESCRIPTION

One aspect of the present invention provides an optical dispersive device such as an OSA having a reflection dispersion grating in a double-pass configuration with an angle-limiting reflector. An embodiment of such an OSA is illustrated in FIG. 2 and will now be described.

With reference to FIG. 2, an OSA assembly 100, hereinafter referred to as the OSA 100, includes a wavelength dispersive element 40 for receiving an input light beam 18 propagating in an input direction from an input lens 21 and for outputting at least a portion thereof as an output light beam 25 in an output direction towards an output lens 20. In the following, where it does not lead to a confusion, we will be referring to a light beam propagating and to the direction of its propagation using a same reference numeral, so that for example the direction of propagation of the input beam 18 will be referred to as the input direction 18, and the direction of propagation of the output beam 25 will be referred to as the output direction 25. In the embodiment described herein the wavelength dispersive element 40 is in the form of a reflective diffraction grating 40, which is hereinafter also referred to as the optical grating 40 or simply as a the grating 40. Also in the shown embodiment the output and input directions 25, 18 are parallel to each other, although this is generally not required for the present intention to operate. The output lens 20 collects the output light 25 diffracted by the grating 40 in its direction and may focus it upon a photodetector (not shown), or may first couple it into an optical fiber (not shown). The input lens 21 collimates the input light beam 18, which impinges upon the grating 40 and is angularly dispersed by the grating action in a dispersion plane of the grating in dependence upon the light wavelength. In the shown embodiment the input light 18 impinges upon the grating 40 generally perpendicularly to groves of the grating, so that the plane of incidence of the input light substantially coincides with the dispersion plane of the grating 40, although this feature is not generally required in the present invention.

The OSA 100 further includes a reflector 60 in a Littman type configuration with the grating 40. The reflector 60 has two reflecting surfaces arranged in a configuration of a two-dimensional corner reflector extended in the dispersion plane of the grating 40, so as to receive the input light 18 of a particular wavelength that is diffracted by the grating 40 in a forward direction 13, and return it back towards the grating 60 along a return direction 33. For light propagating in the dispersion plane (x,z) the reflector 60 operates as a mirror providing specular reflection, while for light propagating in a plane (y,z) normal to the dispersion plane, the reflector 60 operates similarly to a corner reflector in a limited angular range, shifting the return light in the direction normal to the dispersion plane. In a desired mode of operation of the OSA 100, the forward direction 13 and the return direction 33 are parallel to each other as illustrated in FIG. 2, so that the returned light is directed towards the output lens 20 after diffracting by the grating second time in the same diffraction order. For a given relative orientation between the reflector 60 and the grating 40, this condition selects a particular wavelength λ_{H} that can enter the OSA 100 from the input lens 21 and exit it from the output lens 20, while ideally blocking all other wavelength from the operating wavelength range (λₘᵢₙ, λₘₐₓ) of the OSA 100.

In the shown embodiment, the reflector 60 is formed of two prisms 1 and 6 and a mirror 11, with the back face of the second prism 6 reflecting the light towards the mirror 11. The first prism 1 and the second prism 6 are sequentially disposed one after another in an optical path of the diffracted beam propagating in the forward direction 13, with their longitudinal axes directed along the x axis in the diffraction plane of the grating 40 and oriented at a small angle α_{g} to the plane of the grating 40; this angle may be varied in operation by rotating either the grating 40 or the reflector 60 about an axis that is normal to the dispersion plane of the grating 40. The mirror 11 receives the diffracted light from a reflective back surface of the second prism 6 and reflects the diffracted light back towards the grating 40 for a second diffraction thereupon. In the following and preceding description, a Cartesian coordinate system (x,y,z) indicated in FIG. 2 is used to assist in understanding; in this coordinate system, the dispersion plane is parallel to the (x, z) plane, with the (y, z) plane normal to the plane of the mirror 11 and faces of the prisms 1 and 6, so that light incident upon the reflector 60 from the grating along the z axis is returned back to the grating also along the z axis direction, albeit with a shift along the y axis, i.e. in the direction normal to the dispersion plane.

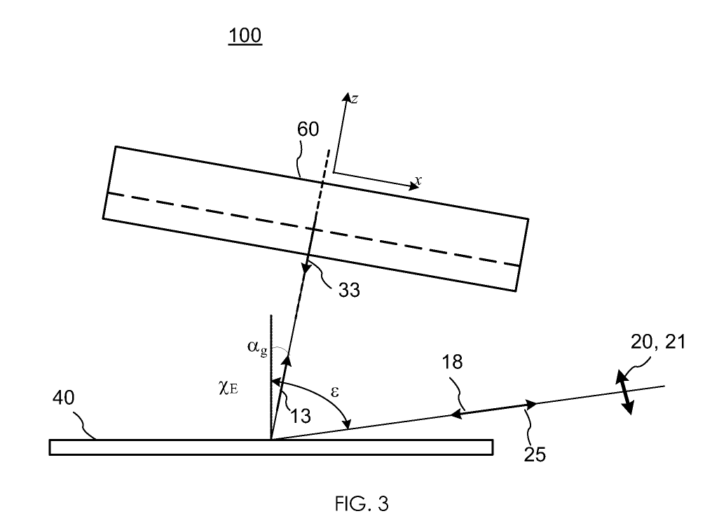

FIG. 3 schematically shows a projection of the OSA 100 on the dispersion plane (x,z) of the grating 40 and illustrates the propagation of light having the wavelength λ_{H}, which is also referred to herein as the first wavelength, in the OSA 100 in projection on the dispersion plane. The input light 18 propagating in the input direction impinges upon the grating 40 at an incidence angle ε, and is diffracted in the first order towards the reflector 60 at a first diffraction angle, which for the selected wavelength λ_{H} is equal to α_{g}. Accordingly, at the wavelength λ_{H}, the diffracted light 13 is directed to impinge upon the reflector 60 at a normal angle of incidence in projection on the diffraction plane, and is returned back toward the grating 40 along the return direction 33 without any lateral displacement in the diffraction plane. A corresponding condition is give by the grating equation in the form

sin(ε)+sin(α_{g})=k·λ_{H}/g, (1)

where k=0, 1,. . . is a diffraction order, and g is a period of the grating. Exemplary embodiments of the present invention are described herein with reference to the OSA wherein the grating is designed to operate in the first dispersion order, k=1, however other embodiments can utilize higher dispersion orders. FIG. 3 illustrates the desired optical mode of the OSA 100, which is referred to herein as the H mode or the double-pass mode, wherein light that enters the OSA 100 along the input direction 18 leaves the OSA along the output direction 25 after experiencing two diffractions at the grating 40. For a given input incidence angle ε at the grating and a particular orientation of the grating 40 with respect to the reflector 60 as defined by the grating angle α_{g}, equation (1) defines the wavelength λ_{H} of the H mode.

It is commonly accepted in the art that input light with wavelengths away from λ_{H} will be diffracted from the grating 40 at differing angles not equal to α_{g}, and therefore will travel along differing paths and thus will not reach the photodetector placed after the output lens 20, except for a relatively narrow wavelength range about the nominal wavelength λ_{H}, as defined by the OSA resolution that depends, inter alia, by the length of the optical path in the OSA and size and numerical aperture of the lens 20.

We found however that the OSA 100 may potentially support other multi-pass modes, wherein input light of wavelengths that are relatively far away from the “nominal” wavelength λ_{H} enters and exits the OSA 100 along the same routes as the light of the H mode at the wavelength λ_{H}, but travels more than twice between the grating 40 and the reflector 60. These undesired modes, if exist, may disadvantageously affect the performance OSA 100, in particular its spectral selectivity, by making it impossible for the OSA 100 to select light at the nominal wavelength λ_{H} separately from light of the other wavelengths corresponding to the other multi-pass modes.

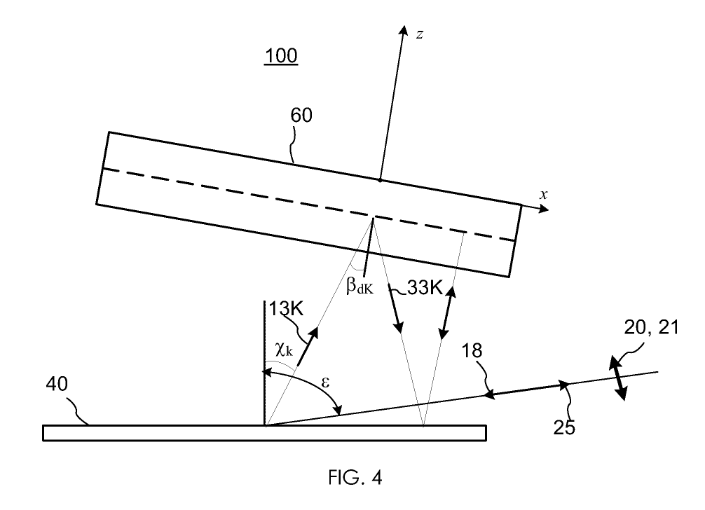

Referring now to FIG. 4, there is shown, in projection on the dispersion plane of the grating 40, one undesirable mode that may potentially exist in the OSA 100 and is referred to herein as the K mode. This mode is a four-pass mode and corresponds to two first-order diffractions and two zero order diffractions, i.e. specular reflections, at the grating 40. Light of this mode is referred to herein as the K light, with an optical path thereof within the OSA 100 referred to as the K path. The K light has a wavelength λ_{K} that is such that light of this wavelength, when incident upon the grating 40 at the incidence angle ε, has a first order diffraction angle χ_{K} satisfying the following condition (2):

χ_{K}=3α_{g} (2).

The K light diffracted in the first order by the grating 40 propagates in a direction 13K towards the reflector 60, impinges thereupon at an angle β_{dK}=2α_{g}, is specularly reflected therefrom back towards the grating 40 with an incidence angle α_{g} thereto, and then speculalry reflected by the grating 40 back towards the reflector 60 at a normal angle of incidence to the reflector in projection on the dispersion plane. The K ray then retraces its pass in the reverse direction, exiting the OSA 100 through the output lens 20 along the OSA output path 25. The corresponding wavelength λ_{K} is given by the grating equation in the following form (3):

sin(ε)+sin(3α)=λ_{K}/g, (3)

Accordingly, if both wavelengths λ_{K} and λ_{H} are within the operating range of the OSA 100, the OSA 100 may not be able to distinguish between these two wavelength if both may be present in the input light beam in the OSA 100.

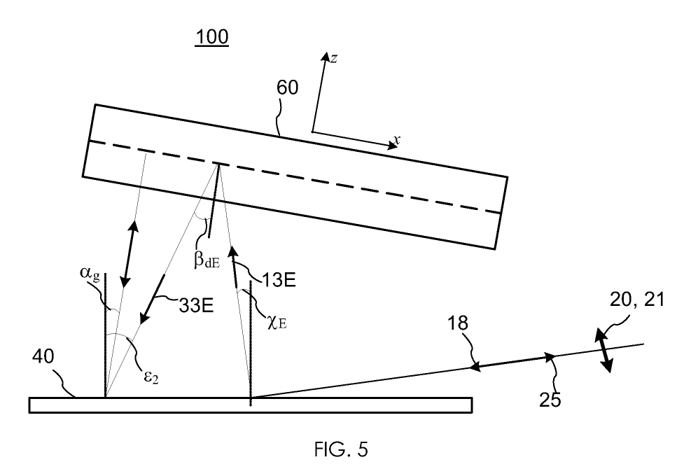

Referring now to FIG. 5, there is shown, in projection on the dispersion plane of the grating 40, an optical path of another undesirable mode that may potentially exist in the OSA 100 and is referred to herein as the E mode. Light of this mode is referred to herein as the E light, with an optical path thereof within the OSA 100 referred to as the E path. This mode is a four-pass mode and corresponds to four first-order diffractions at the grating 40. The E light that is incident upon the grating 40 at the input incidence angle ε is diffracted therefrom in a first order and directed towards the reflector 60 at a diffraction angle χ_{E}, impinging upon the reflector 40 along a direction 13E at a dispersion-plane incidence angle

β_{dE}=α_{g}−χ_{E}, (4)

where λ_{E} satisfies the grating equation in the form

sin(ε)+sin(χ_{E})=λ_{E}/g. (5)

The E light is then reflected back in the return direction 33E and hits the grating 40 a second time at an incidence angle

ε₂=2α_{g}−χ_{E} (6)

The grating 40 then may diffract the E light in the first order a second time back to the reflector 60 at a diffraction angle α_{g} perpendicularly to the reflector 60 in the projection on the dispersion plane, provided that the wavelength λ_{E} satisfies also the grating equation in the form

sin(ε₂)+sin(α_{g})=χ_{E}/g (7)

The reflector 60 than reflects the twice diffracted light E back along the same path, to finally be collected by the output lens 20 after experiencing four first-order diffractions upon the grating 40.

The E light will be returned by the OSA 100 along the same path provided that the two conditions (5) and (7) are both satisfied. From equations (4)-(7), we obtain:

$$\begin{matrix}{χ}_{E} = a sin ( \frac{sin ( {α}_{g} ) - sin ( ɛ )}{2 cos ( {α}_{g} )} ) + {α}_{g} , \\ and & ( 8 ) \\ {β}_{dE} = a sin ( \frac{sin ( {α}_{g} ) - sin ( ɛ )}{2 cos ( {α}_{g} )} ) . & ( 9 )\end{matrix}$$

The wavelength λ_{E} of the E mode can be found by substituting equation (8) into equation (5).

Accordingly, if both wavelengths λ_{H} and λ_{E} are within the operating range of the OSA 100, the output beam of the OSA 100 may include not only light at the nominal wavelength λ_{H}, but also light at the wavelengths λ_{E} and/or λ_{K} thereby possibly leading to errors in the spectral measurements of the input light.

Note that the E and K modes are just two examples of possible multi pass modes that can potentially be present in the OSA 100 or a similar dispersive device; other undesirable multi-pass modes wherein light experiences more than two diffractions at the grating 40 can also be present and may disadvantageously affect the performance of the OSA 100 if those wavelength are within the operating wavelength range thereof.

Advantageously, the present invention provides a solution for this problem by utilizing a novel angle limiting reflector (ALR) as the reflector 60, which effectively suppresses the undesired modes in the OSA 100, blocking the respective optical paths. Before describing the operation of the ARL of the present invention in detail, we note that the dispersion plane angles of incidence β_{dE} and β_{dK} upon the reflector 60 of the undesirable modes E and K exceed in absolute value the dispersion-plane angle of incidence β_{dH}=0 of the nominal mode H. Accordingly, by using an ALR as the reflector 60 which can accept only a limited range of incidence angles that does not include the angles of incidence of the undesired modes, these undesired modes can be suppressed.

By way of example, the OSA 100 has an operating wavelength range from 1250 nm to 1650 nm, a grating 40 having 900 lines/mm, ε=80°, α_{g} varying from α_{g min}=8.5° at 1250 nm to α_{g max}=30° at 1650 nm, we obtain β_{dK}=2α_{g min}=16.1° at λ_{K}=λₘᵢₙ=1250 nm, β_{dB}=16.2° at λ_{E}=1650 nm. For this grating and the operating wavelength range, the reflector 60 should have a limited angular acceptance range, or limited numerical aperture, that is such that the reflector 60 does not reflect light of the E mode with an angle of incidence in the dispersion plane β_{d} larger then 16.1°. In other embodiments with a different groove density of the grating and/or different operating wavelength range, the desired maximum acceptance angle β_{d max} in the dispersion-plane of the reflector 60 may have a different value, and be defined by a different multi-pass mode. In the following, the wavelength λ_{H} of the “desired” H mode will also be referred to as the first wavelength, while the wavelength λ_{E} of the undesired multi-pass mode that has the smallest angle of incidence at the reflector 60 within the operating wavelength range of the OSA will be referred to herein as the second wavelength.

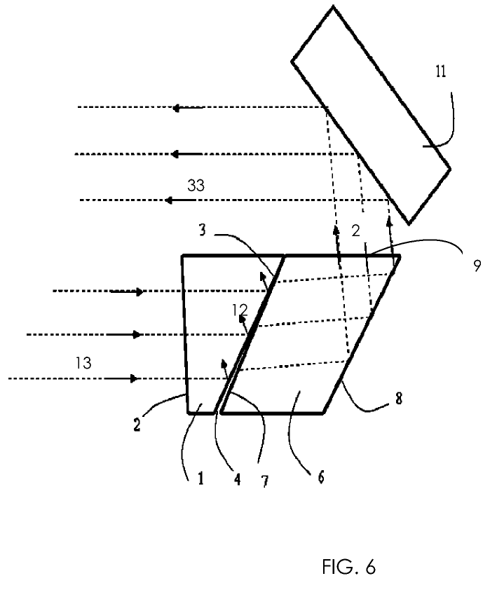

Exemplary embodiments of the reflector 60 of the OSA 100 will now be described in detail with reference to FIGS. 6-10. According to the present invention, the reflector 60 is an angle-limiting reflector, i.e. it reflects input light within a pre-defined range of angles of incidence, but effectively blocks undesired light, such as the E light and/or the K light, that is directed thereupon at angles of incidence that are outside the pre-defined range of angles. The reflector 60, which is a feature of the present invention, will also be referred to hereinbelow as the ALR 60.

Referring now to FIG. 6, there is schematically shown a projection of the ALR 60, in one embodiment thereof, on a plane (y, z) normal to the dispersion plane of the grating 40 and to the longitudinal axes and faces of the prisms 1 and 6; this plane will also be referred to hereinafter as the reflector plane. FIG. 6 also illustrates, in projection on the reflector plane, the propagation of the light received by the ALR 60 from the grating 40. In the context of the ALR 60 description, the diffracted beam 13 received at the first prism 1 from the grating 40 may be referred to as the forward beam 13 or the ALR input beam 13, and the beam 33 that the ALR 60 returns to the grating 40 may be referred to as the return beam 33 or the ALR output beam 33. The propagation direction of the forward beam 13 and the return beam 33 may be referred to as the forward or (ALR) input direction 13 and the return or (ALR) output direction 33, respectively.

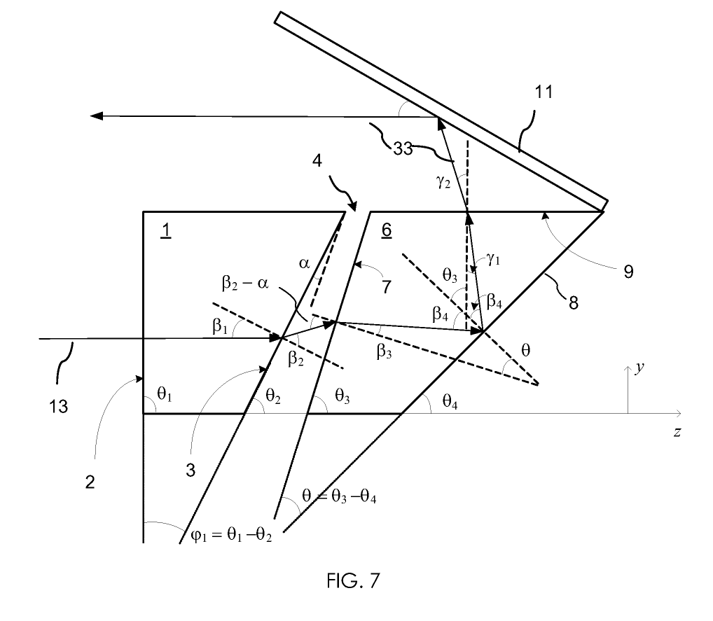

The ALR 60 includes the first prism 1 optically followed by the second prisms 6, each made of a suitable optical transmissive material such as but not limited to glass, quartz, silicon, suitable plastic, and alike. In embodiments described herein the prisms 1 and 6 are made of a same material to save cost and simplify optical design; accordingly they have a same refraction index n. In other embodiments the prisms 1 and 6 may be made of differing materials that are transmissive in the wavelength range of interest for a target application. The first and second prisms 1, 6 are disposed in the optical path of the forward light beam 13, as illustrated also in FIGS. 2, 3. The first prism 1 has a wedge-like shape and has a light input face 2 and a light output face 3 that are not parallel to each other. The second prism 6 is disposed with a light input face 7 proximate to the light output face 2 of the first prism 1, but spaced apart therefrom by a distance greater than the wavelength, forming a gap 4 therebetween. The output face 3 of the first prism 1 is slanted with respect to the input face 2 thereof at a first vertex angle φ₁, and is also slanted with respect to the dispersion plane (x, z) at a second angle θ₂ as shown in FIG. 7 and described hereinbelow in further detail. These angles are selected so that rays of the forward beam 13 within a desired range of angles of incidence are transmitted through the gap 4 into the prism 6, while undesired rays exceeding a pre-determined incidence angle are deflected away by means of a total internal reflection on the output face 3 of the first prism 1 as illustrated with arrows 12, imparting thereby a desired angular selectivity upon the ALR 60.

Preferably, the input face 7 of the second prism 6 is not parallel to the output face 3 of the first prism 1, but inclined with respect to it by a small angle α that is referred to hereinafter as the gap vertex angle, as illustrated in FIG. 7, so as to avoid undesirable etalon-like effects due to multiple reflections within the gap. Accordingly, the gap 4 is tilted with respect to the forward light beam 13 and has a wedge-like shape. The gap vertex angle α of the gap 4 may be selected to spatially separate light passing through the gap 4 without reflections therein from light experiencing such reflections in the gap by a suitable distance in an image plane of the device, for example by a distance exceeding the radius of a photosensitive area of the photodetector used to detect the output beam 25. From this condition, determines a desired minimum value of the gap vertex angle α may be obtained as known in the arts for each particular configuration of the OSA 100. Skilled in the art persons will appreciate that this desired minimum value depends on a focus distance of the used lens, e.g. the output lens 20. However, as will become clear from the following description, increasing the gap vertex angle α far above the desired minimum value for suppressing the multi-pass interference may be disadvantageous as it may lead to undesirable angular dispersion upon transmission through the gap. By way of example, the vertex angle α may be in the range of 0.2° to 3°, and preferably in the range of 0.3° to 2°, but may also be outside of this range.

The second prism 6 has a reflecting face 8 that is opposite to the input face 7, and a light output face 9 facing the mirror 11. The reflecting face 8, which is also referred to herein as the first reflecting face, is oriented to receive the light beam 13 impinging thereupon after passing the gap 4 and to reflect it, for example by means of a total internal reflection, as a redirected beam 23 towards the light output face 9 of the second prism 6. The mirror 11 is tilted with respect to the reflecting face 8 of the second prism 6 at an angle that is selected to reflect the redirected beam 23 in the output direction 33 in the form of the output, or return beam 33. The output direction 33 is parallel to and opposite to the forward direction 13.

We found that the wedge-like shape of the gap 4, although beneficial for suppressing undesirable interference effects in the gap 4, have an effect of contributing an angular dispersion into the beam 13 passing therethrough, which would have been absent for a uniform gap of constant thickness. This angular dispersion associated with the gap 4, which may be undesirable in some applications, will be referred to herein as the first dispersion; it appears as a result of the refraction of light at the prism/air interfaces at the gap 4 and the chromatic dispersion in the prisms 1 and 6, wherein the angle of refraction is a function of the refractive index of the prisms n, which is wavelength dependent, i.e. n≅n(λ).

Advantageously, we found that the contribution of the wedge-shaped gap 4 in the angular dispersion of the return light 33 can be substantially or at least partially compensated by suitably orienting the input face 2 of the first prism 1, or the output face 9 of the second prism 6 relative to their respect directions of incidence. In particular, according to one feature of the present invention, spatial orientation of at least one of: the input face 2 of the first prism 3, the output face 9 of the second prism 6, and the reflecting face 8 of the second prism 6 is selected for imparting on the light beam, upon passing through the output surface 9 of the second prism 6 or the input surface 2 of the first prism 1, a second angular dispersion that is opposite to the first chromatic dispersion, so as to at least partially compensate it.

Generally, an increase in the wavelength of a beam incident upon a tilted face of a prism will cause the refracted beam to steer, i.e. rotate, either clock-wise or counter-clock-wise due to the chromatic dispersion in the prism. This beam steering caused by a wavelength change is referred to as the angular dispersion, and is characterized by the rate of change of the beam angle with respect to the wavelength. The direction of the ray rotation defines the sign of the angular dispersion; by way of example, a positive angular dispersion may correspond to a counter-clock-wise rotation of the refracted beam. The sign of the angular dispersion that is imparted upon the beam by crossing of each prism face depends upon the direction of the beam's tilt with respect to the interface, or the sign of the corresponding incidence angle, and upon whether the beam enters or exits the prism (or, generally, a more optically dense matter). When a light beam passes through a sequence of spaced prisms without experiencing internal reflections, each two prism-air interfaces successively crossed by the beam contribute into the overall angular dispersion of the output beam with the same sign if the respective prism faces have opposite tilts, and with opposite signs if the faces are tilted in the same direction. An internal reflection upon a prisms' face changes the direction of the ray rotation and thus flips the signs of angular dispersion contributions from all following refraction events.

With reference to FIG. 7, the propagation of the forward light beam 13 through the first and second prisms 1, 6 will now be described more in detail to gain an insight into the angle limiting and angular dispersion properties of the ALR 60. In this figure, as well as in the preceding and following figures of this specification, the shown dimensions of the prisms 1 and 6 and of the gap 4 therebetween are chosen for convenience of representation and are not to scale. The dashed lines in FIG. 7 represent surface normals to respective surfaces, and the forward beam 13 is represented by a center ray thereof. The input and output faces 2, 3 of the first prism 1 will also be referred to herein as the first and second faces, respectively, the input and output faces 7, 8 of the second prism 6 will also be referred to herein as the third and fifth faces, respectively, and the reflecting face 8 of the second prism 6 will also be referred to as the forth face of the prism system 1, 6.

Continuing to refer to FIG. 7, the orientation of the first, second, third and forth faces of the prism system 1, 6 may be defined by the angles θ₁ to θ₄ respectively, which these faces form with the dispersion plane (x,z), or generally with a nominal plane of incidence of the forward beam 13, as indicated in the figure. These angles will also be referred to herein as the first, second, third and forth angles, respectively, or as orientation angles of the respective faces. The second angle θ₂ defines the orientation of the gap 4 with respect to the dispersion plane, and is also referred to as the gap orientation angle θ₂. In the embodiment shown in FIG. 7, θ₁=90° and the central ray of the forward beam 13 has a normal incidence upon the first face 2 and is transmitted therethrough without changing direction to impinge at the second face 3 at an incidence angle β₁, and is refracted upon the second face to exit the first prism 1 at a first refraction angle β₂, in accordance with the refraction equation (1):

sin(β₂)=n sin(β₁) (10)

The effect of the total internal reflection (TIR) upon the second face 3 defines an acceptance angle of the ALR 60, i.e. a maximum angle of incidence β_{TIR} for the input light 13 to be transmitted through the gap 4 and ultimately to contribute into the return light beam 33:

β_{TIR}−a sin(1/n) (11)

Accordingly, input light 13 that propagates in the reflector plane that is normal to the first face 2 having the angle of incidence β₁<β_{TIR} will be transmitted through the gap 4, while light with angle of incidence substantially equal or exceeding the critical acceptance angle β_{TIR} is deflected away from the optical path by the second face 3 and does not contribute into the return beam 33 of the ALR 60. Therefore, the gap 4 functions as an angle limiting element of the ARL 60.

By way of example, the prisms 1 and 6 are made of BK7 glass and have the refraction coefficient n=1.504 at the wavelength λ=1250 nm, yielding the value of the critical angle β_{TIR}−41.670, corresponding to θ₂ min˜48.32°.

According to an aspect of the present invention, the shape and orientation of the first prism 1, and in particular the second angle θ₂ that defines the tilt of the output face 3 of the first prism 1 with respect to the dispersion plane and therefore the orientation of the gap 4, are selected so that the total internal reflection at the output face 3 of the first prism 1 prevents light of any wavelength in the operating wavelength range from contributing into the output light beam 25 after travelling more than twice between the reflecting grating 40 and the reflector 60.

In the embodiments described herein, the first angle θ₁ and the second (output face) angle θ₂ are selected so as to block input light having wavelengths λₘᵢₙ and λₘₐₓ at the edges of the operating wavelength range of the OSA 100 from propagating along either the K and E optical paths as illustrated in FIGS. 4 and 5, by causing light propagating along these optical paths to experience the TIR at the output face 3 of the prism 1. Note first that the angles β_{dK} and β_{dE} of the undesired K and E modes shown in FIGS. 4,5 are defined in the dispersion plane, which is normal to the reflector plane, i.e. the plane of FIG. 7, and is slanted with respect to the output face 3 by the second angle θ₂. Accordingly, the planes of incidence of the undesired K and E rays upon the output face 3 of the first prism 1 do not coincide with either the dispersion plane or the reflector plane. Considering further only the E mode as having the smallest angle of incidence upon the reflector among all undesired multi-pass modes, the “true” angle of incidence β_{E} of the E ray upon the output face 3 depends both on β_{dE} and θ₂.

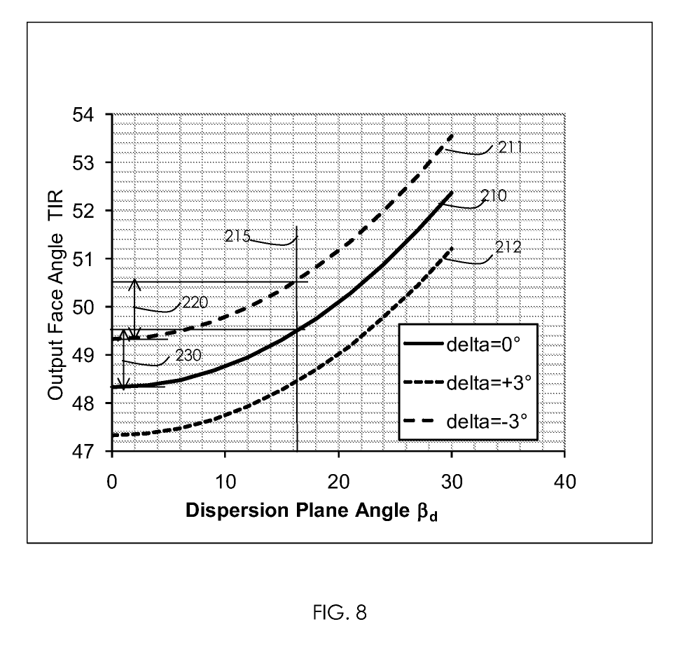

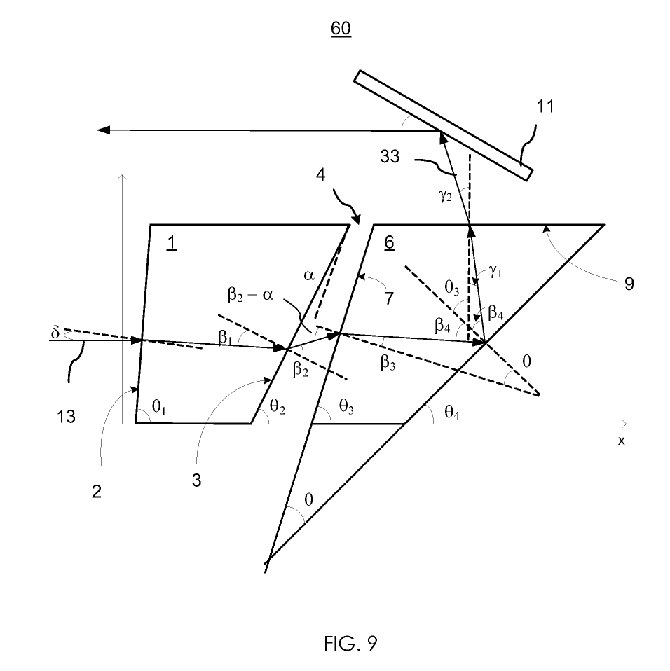

Referring to FIG. 8, curves 210-212 illustrate by way of example a maximum value of the second angle θ₂ for which the TIR condition (11) at the gap 4 is satisfied for light of an undesired multi-pass beam in the OSA 100, so that that light is deflected away from the optical path, in dependence upon the dispersion-plane angle of incidence β_{d} of the undesired multi-pass beam; n=1.504 is assumed. Curve 210 corresponds to the embodiment of FIG. 7 wherein θ₁=90°. Curves 211 and 213 corresponds to embodiments wherein the first face 2 is tilted relative to the normal incidence by a first tilt angle λ, where positive λ corresponds to the tilt orientation illustrated in FIG. 9; curve 211 corresponds to λ=−3°, curve 212 corresponds to δ=+3°. According to the invention, the second, or gap orientation angle θ₂ is selected so that the desired beam 13 of the H mode having β_{d}=0 is transmitted through the gap 4 between the prisms 1 and 6, while the undesired K (and E) mode beams are reflected for any wavelength in the operating wavelength range. For exemplary parameters of the OSA 100 recited hereinabove, wherein the minimum β_{d}=β_{dK}=16.1° as indicated in FIG. 8 with a vertical line 215, the corresponding ranges of the gap orientation angle θ₂ are indicated with arrows 220 and 230 for embodiments with δ=−3° and δ=0, respectively. For example, δ=0 corresponds to a range 230 of the second angle θ₂ between about 48.4° as required to totally reflect the beam of the undesired K mode, and about 49.5° as required to transmit the desired light of the H mode; for example θ₂=49° may be selected.

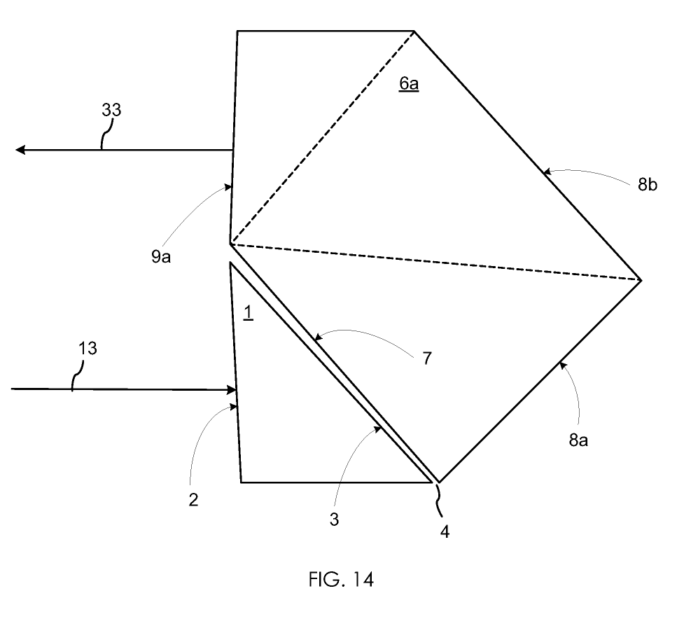

In another embodiment wherein the input face 2 is tilted with respect to the desired incident beam 13 of the H mode by δ=−3 degrees as illustrated in FIGS. 3 and 14, the output face angle θ₂ should be in the range 220 between 49.4° and 50.5 degrees, for example θ₂=50° may be selected.

In another embodiment wherein the input face 2 is tilted with respect to the desired incident beam 13 of the H mode by δ=3 degrees as illustrated in FIG. 9, the output face angle θ₂ should be between 47.3° and 48.4 degrees, for example θ₂=48° may be selected.

Of course in other embodiments, for example using materials with a different refractive coefficient, a different grating, and/or a different operating wavelength range, the gap orientation angle θ₂ of the first prism for blocking undesired multi-pass modes may have other values.

Considering now only rays of the desired (H) mode of the OSA 100 propagating in the reflector plane (y, z) with the incidence angles β₁<β_{TIR} within the acceptance range of the ALR 60, the beam 13 experiences a second refraction at the third face 7 entering the second prism 6 with a refraction angle β₃ defined by equation (3)

sin(β₂−α)=n sin(β₃) (3)

where the vertex angle α of the gap 4 satisfies equation (4)

α=θ₃−θ₂. (4)

The refraction angle β₃ defines the optical path of the beam 13 in the second prism 6 for a give shape thereof. For small values of the gap vertex angle α, i.e. less than about 15°, β₃ can be estimated from the following equation (5):

sin(β₃)≅cos α sin(β₁)−α\sqrt{1/n²−sin²β₁}(5)

Accordingly, the non-zero vertex angle of the gap 4 induces an angular dispersion upon the beam 13 propagating within the second prism 6, due to the non-zero chromatic dispersion of the refractive index n. If the angle of incidence β₁ is sufficiently far from the TIR condition (1), equation (5) can be further simplified, yielding the following approximate expression for the refraction angle β₃ at the input face 7 of the second prism 6:

β₃≅β₁−α\sqrt{1/n²−sin² β₁} (6)

with the angular dispersion coefficient

$$\frac{d {β}_{3}}{d λ} ≅ \frac{α {n}_{λ}}{{n}^{2} \sqrt{1 - {n}^{2} {sin}^{2} {β}_{λ}}} \qquad ( 7 )$$

where n_{λ}=dn/dλ is the chromatic dispersion coefficient of the prism material.

After entering the prism 6 through the input face thereof, the beam 13 is specularly reflected from the forth face 8, and impinges upon the prism output face 9 at an angle of incidence γ₁. Assuming that the fifth, i.e. output face 9 is parallel to the x-axis, the corresponding angle of incidence γ₁ is given by the equation (8a):

γ₁=2θ₄−θ₃−β₃ (8a)

where

θ₃=θ₂+α (8b)

According to a feature of the present invention, the angular dispersion induced by the refraction of light at interfaces 3, 7 of the gap 4 may be at least partially compensated by inducing a second angular dispersion of an opposite sign at the output face 9 of the second prism 6. This can be accomplished by selecting the prism 6 in which the reflecting face 8 is oriented in such a way with respect to the output face 9 that the beam 13 impinges upon the output face 9 non-orthogonally thereto, i.e. with the non-zero angle of incidence γ₁. A value of the incidence angle γ₁ that provides at least partial compensation of the angular dispersions associated with the wedge-shaped gap 4 can be estimated from equations (7) and (8), and also using the Snell's law for the refraction at the output face 9, which in the small angle approximation takes the following simple form:

γ₂=n·γ₁ (9)

Here γ₂ is the angle of refraction at the output face 9, wavelength dependence of which defines the total angular dispersion of the return beam 33, and can be approximately characterized by the angular dispersion coefficient D=dγ₂/dλ, which includes contributions from the gap 4 and from the refraction at the output face 9:

$$\frac{d {γ}_{2}}{d λ} = {n}_{λ} {γ}_{1} - n \frac{d {β}_{3}}{d λ} . \qquad ( 10 )$$

The first term in the right hand side (RHS) of equation (10),

D_{g}=n_{λ}γ₁, (11)

represents the contribution into the angular diffraction of the output light 33 from the refraction at the output face 9, which is also referred to herein as the first angular chromatic dispersion. The second term in the RHS of equation (10),

$${D}_{out} = - n \frac{d {β}_{3}}{d λ} = - \frac{α {n}_{λ}}{n \sqrt{1 - {n}^{2} {sin}^{2} {β}_{2}}} \qquad ( 12 )$$

represents the contribution into the angular diffraction of the output light 33 from the transmission through the gap 4, which is also referred to herein as the second angular chromatic dispersion. One can see that in the illustrated embodiment these terms are of the opposite sign, and cancel each other when the following approximate condition holds, as maybe obtained from equations (10) and (7):

$${γ}_{1} = \frac{n}{{n}_{λ}} \frac{d {β}_{3}}{d λ} ≅ \frac{α}{n \sqrt{1 - {n}^{2} {sin}^{2} {β}_{1}}} \qquad ( 13 )$$

By way of example, the prisms 1 and 6 are made of BK7 glass and have the refraction coefficient n=1.5013 at the wavelength λ=1650 nm, the second face 3 is tilted at an angle θ₂=49.75° to the dispersion plane, β₁=90°−θ₂=40.25°, α=0.55° yielding an estimated value for the output angle of incidence γ₁≅1.5° to achieve approximate compensation of the angular dispersion caused by the gap 4.

In the embodiment considered hereinabove the first prism 1 is such that the central rays of the forward light beam 13 has the normal incidence at the input face 2 of the first prism 1. However, in another embodiment the input face 2 can be tilted, for example by an angle δ=3°, with respect to the input beam direction to avoid back reflections therefrom as known in the art, for example as illustrated in FIG. 5. In this case, the refraction of the input light beam 13 of the ALR 60 at the input face 2 also contributes into the overall angular dispersion and must be taken into account, with the sign of its contribution depending upon the orientation of the tilt. For small values of the input tilt angle δ and the gap vertex angle α, the contribution Dᵢₙ of the first face 2 into the overall angular dispersion D of the output beam 33 may be approximately estimated as

$${D}_{tn} = {n}_{λ} \frac{δ}{n} , \qquad ( 14 )$$

with the sign of this contribution depending on the direction of the face 2 tilt; i.e. the input tilt angle δ is positive if the input face 2 is inclined in the same direction as the output face 3 of the first prism 1, and is negative if the input face 2 is inclined in the same direction as the output face 3 of the first prism 1.

The overall angular dispersion of the beam 33 can be estimated in the approximation of small angles δ, α as

D=Dᵢₙ+D_{g}+Dₒᵤₜ (15)

The angle of incidence at the output face 9 γ₁ can be in this embodiment estimated using the following equation (16):

$${γ}_{1} ≅ \frac{1}{n} ( δ - \frac{α}{\sqrt{1 - {n}^{2} {sin}^{2} {β}_{2}}} ) \qquad ( 16 )$$

In equation (16) as pertains to the embodiment of FIG. 8, the gap angle α is positive if the third face 7 has a smaller tilt than the second face 3, i.e. if θ₃>θ₂, and is negative otherwise; the input and output incidence angles δ and γ₁ are positive when counted counterclockwise from the respective surface normals, and are negative otherwise. In other words, the output incidence angle γ₁ is positive if the beam incident upon the output face 9 is tilted towards the return direction, i.e. the direction of the return beam 33; a positive tilt angle δ corresponds to the input face 2 and the output face 3 of the first prism 1 tilted in the same direction. In this case the tilting of the input face 2 at least partially compensates for the angular dispersion induced by gap 4.

However, in some embodiments it may be preferable for the input face 2 to reflect light away from the optical path of the return beam 33; in this case, for the shown shape and orientation of the gap 4, the contributions of the input faced 2 and the gap 4 into the angular dispersion of the output light 33 are of the same sign, requiring a larger output incidence angle γ₁. By way of example, δ=3°, n=1.504, β₁=41.45°, yielding an estimated optimal value for output angle γ₁˜5.2° in an embodiment wherein the contributions of the gap 4 and the input face 2 add to each other.

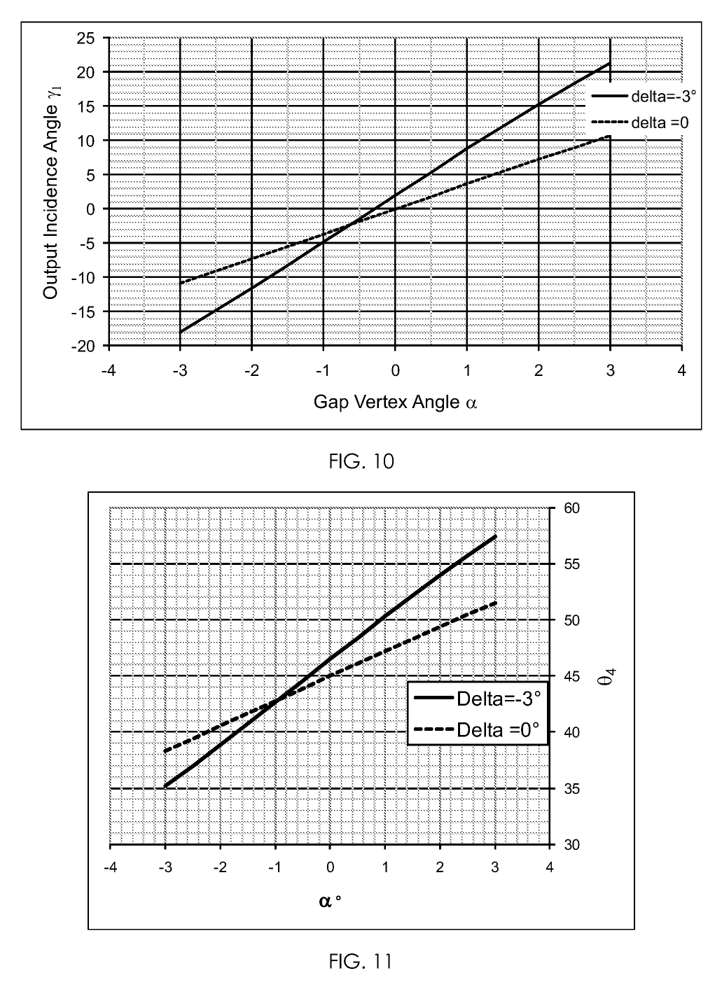

It will be appreciated that the equation given hereinbelow are approximate and are for guidance only, and more accurate calculations of the optimal prism angles will have to be performed in each particular application. FIGS. 10-12 illustrate exemplary results of such computations.

FIG. 10 illustrates exemplary dependences of the optimum incidence angle γ₁ on the output face 9 versus the gap vertex angle α for a non-tiled input face 2 of the first prism 1 (dashed curve, δ=0°) and for the case of the δ=−3° tilt (solid line) of the input face 2 for n=1.504. By way of example, in one embodiment having δ=−3° and θ₂=49.75° the angle γ₁ maybe in the range of 3.5 and 9°, depending on α.

FIG. 11 illustrates exemplary dependences of the optimum tilt angle θ₄ of the reflective face 8 upon the gap vertex angle α for a non-tiled input face 2 of the first prism 1 (dashed curve, δ=0°) and for the case of the δ=−3° tilt of the input face 2 (solid line) for the same parameter values as in FIG. 10.

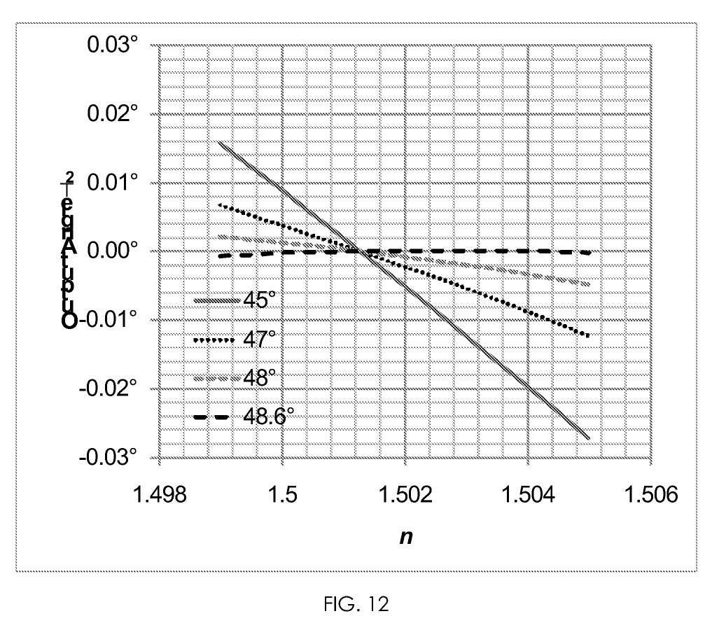

FIG. 12 illustrates the angular dispersion of the output beam 33 in terms of the dependence of the output angle γ₂ of the light leaving the second prism 6 versus the refractive index n, which is a known function of the wavelength, for four different values of the reflecting face angle θ₄; here, δ=−3°, θ₂=49.75°, α=0.55°. Clearly, the use of a conterminal 45° tilt of the reflective surface 8 leads to a noticeable angular dispersion of the output beam 33, which is greatly reduced when the reflective face 8 of the prism 6 is oriented at θ₄˜48.6°, which is an optimal dispersion compensation orientation in this particular example.

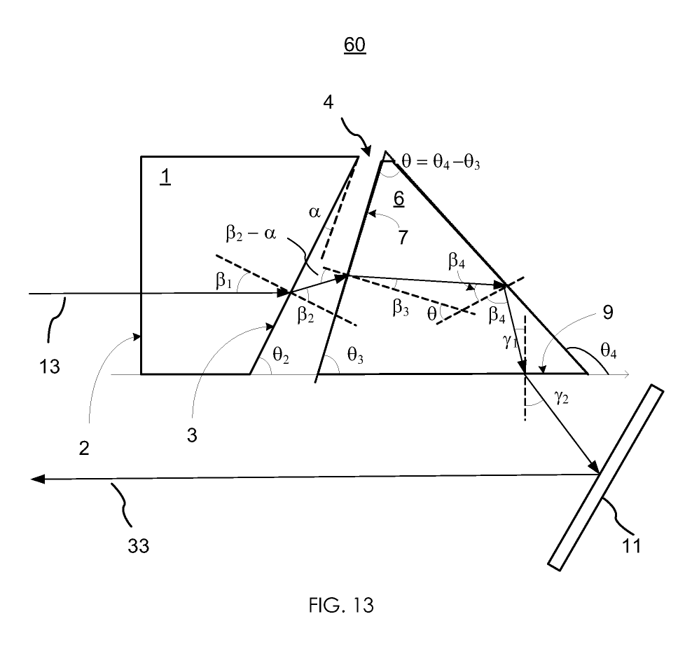

It will be appreciate that other embodiments of the ALR 60 are also possible, with different orientations of the first, second and third faces 2, 3, and 7 relative to the reflecting face 8 and the mirror 11. For example, in one embodiment the gap 4 may be widening toward the mirror 11. In the same or other embodiment, the first prism may be disposed with its narrower side towards the mirror 11. One of such alternative embodiments, which require a negative output tilt angle γ₁ for compensation of the angular dispersion induced by the gap 4, is illustrated in FIG. 13.

In all such embodiments, for given tilt, orientation and and vertex angle of the gap 4, the orientation of at least one of the input face 2 of the first prism 1 and of the reflecting face 8 of the second prism 6 can be selected so as to provide at least partial compensation of the second angular dispersion induce by the transmission of light though the gap 4.

The embodiments of the ALR 60 described hereinabove with reference to FIGS. 2, 6, 7, 9, and 13 all include two reflecting surfaces, one provided by internal reflection at the face 8 of the second prism, and one by the mirror 11. In other embodiments, both reflecting surfaces of the ALR 60 may be provided by internal reflection at prism faces, either of a same prism or different prisms.

With reference to FIG. 14, an embodiment of the ALR 60 is shown wherein the second prism 6, labeled here as “6a”, is a pentaprisms that is spaced from the first prism 1 with a wedge-shaped gap 4, and has two reflecting faces 8a and 8b, and an output face 9a. For a particular choice of the orientation and vertex angle of the gap 4, the orientation of at least one of the input face 2 of the first prism 1, the output face 9a of the second prism 6a, the first reflecting face 8a, and the second reflecting face 8b of the second prism are selected so that angular dispersion accumulated by the input beam while traversing the air-prism interfaces 2, 3 of the first prism 1, is at least partially compensated by the angular dispersion accumulated while traversing the air-prism interfaces 7, 9a of the second prism 2. In one embodiment, the output face 9a of the second prism 6a is not orthogonal to the direction of the output beam 33, so as to affect refraction thereon for compensating angular dispersion contributions from the gap 4 and, if present, the input face 2.

It will be appreciated that mathematical formulas used hereinabove were used merely to assist in understanding of the invention and are not required for practicing the invention, and alternative formulas and/or optical design software may be used to determine various parameters of the aforedescribed components of the OSA 1 and the ARL 60.

The invention has been described hereinabove with reference to specific exemplary embodiments thereof. It will, however, be evident that various modifications and changes may be made thereto within the scope of the invention.

For example, although the OSA assembly 100 described hereinabove utilizes a two-pass configuration, in alternative embodiments the OSA with elements of the present invention may be designed to operate in an m-pass configuration wherein m is greater than 2, wherein input light of the desired mode travels more than twice between the grating and the reflector, while the undesired modes correspond to a different, for example greater than m, number of passes.

In a further example, the OSA 100 may utilize a single lens for shaping and directing the input and output beams of the OSA. The lens or lenses can also be replaced by other appropriate focusing and/or collimating means as known in the art. In a further example, the gap 4 may be filled with other material having an index of refraction smaller than that of the first prism. Although a configuration of the OSA described herein by way of example utilizes a reflective grating, embodiments utilizing a transmission grating can also be easily envisioned.

In a further example, embodiments of the ALR of the present invention can be envisioned wherein the wedge-shaped prism 1 is positioned optically after the reflecting prism 6 to receive light from the output face 9 thereof.

Furthermore, although embodiments of the present invention have been described with reverence to an OSA, the present invention may be embodied in the form of other optical dispersive devices utilizing a grating in a two-pass or, generally, multi-pass configuration, wherein the ALR of the present invention may be advantageously used to block undesired modes. For example, the OSA assembly shown in FIG. 2 may operate as a tunable or fixed optical filter, or used, with appropriate modifications which would be evident to those skilled in the art, as an external reflector of a tunable laser. It should also be understood that each of the preceding embodiments of the present invention may utilize a portion of another embodiment. Of course numerous other embodiments may be envisioned without departing from the spirit and scope of the invention. An ordinary person in the art would be able to construct such embodiments without undue experimentation in light of the present disclosure.

We claim:

1. An optical dispersive device, comprising:
an optical grating for receiving an input light beam along an input direction and for outputting at least a portion thereof as an output light beam in an output direction; and,
a reflector optically coupled with the optical grating for operating in a double-pass configuration therewith, wherein light of a first wavelength diffracted from the grating at a first diffraction angle is reflected by the reflector back towards the optical grating for diffracting thereupon in an output direction for forming the output beam;
wherein the reflector has first and second reflecting surfaces for forming a two-dimensional corner reflector, and comprises:
first and second prisms of an optically transmissive material sequentially positioned with a gap therebetween in an optical path of the light diffracted from the grating, wherein at least the first prism is wedged-shaped having a light output face slanted with respect to a light input face at a first vertex angle, and wherein the light output face thereof is slanted at a second angle with respect to the dispersion plane,
wherein the second angle and the first vertex angle of the first prism are selected so that the light diffracted from the grating at the first diffraction angle is transmitted through the first prism into the second prism, while light that is diffracted from the grating at a second diffraction angle experiences a total internal refraction at the light output surface of the first prism, and is thereby deflecting away from the optical path.

2. The optical dispersive device of claim 1, wherein the second angle and the first vertex angle of the first prism are selected so that the total internal reflection at the output face of the first prism prevents light of any wavelength in the operating wavelength range from contributing into the output light beam after travelling more than twice between the reflecting grating and the reflector.

3. The optical dispersive device of claim 1, wherein the second angle and the first vertex angle of the first prism is selected so that the total internal reflection at the output face of the first prism prevents light of a wavelength at an edge of the operating wavelength range from contributing into the output light beam after travelling more than twice between the reflecting grating and the reflector.

4. The optical dispersive device of claim 1, wherein the second diffraction angle corresponds to a ray of a second wavelength from the input light beam, which in the absence of the total internal reflection would have contributed into the output beam after experiencing more than two passes between the reflecting grating and the corner reflector.

5. The optical dispersive device of claim 1, wherein the gap between the first and second prisms has a wedge-like shape with a vertex angle selected to spatially separate light passing through the gap without reflections therein from light experiencing such reflections in the gap, and wherein light propagating through the gap experiences a first angular chromatic dispersion.

6. The optical dispersive device of claim 5, wherein the light diffracted from the grating impinges upon at least one of the input surface of the first prism and the output surface of the second prism at a non-zero angle of incidence that is selected for imparting upon said light a second angular chromatic dispersion, which is opposite in sign to the first chromatic dispersion for at least partial compensation thereof.

7. The optical dispersive device of claim 6, wherein the first reflective surface is provided by a third face of the second prism which receives light passed through the light output face of the first prism and the light input face of the second prism, and reflects said light towards the light output face of the second prism, and wherein the third face of the second prism is tilted with respect to the light input face thereof at an angle that is selected for providing the desired non-zero angle of incidence at the output face of the second prism.

8. The optical dispersive device of claim 7, further comprising a mirror providing the second reflecting surface, which is disposed optically after the second prism for reflecting the light diffracted by the grating and transmitted through the first and second prisms back towards the grating.

9. The optical dispersive device of claim 5, wherein the second prism has third and forth faces serving as the first and second reflecting surfaces, and wherein the third face is for reflecting the light received from the first prism by towards the forth face, and the forth face is for reflecting the light towards the output surface of the second prism for transmitting towards the grating.

10. An angle limiting reflector for use in a multi-pass optical dispersive device, comprising:
first and second prisms of a light-transmissive material, disposed optically one after another in an optical path of an input light beam for receiving said light beam at an input face of a first prism at a first angle of incidence and for outputting the light beam through an output face of the second prism, wherein the two prisms are disposed with a gap between an output face of the first prism and an input face of the second prism;
wherein the output face of the first prism is slanted with respect to the input face thereof at a first angle that is selected to transmit rays within a desired range of angles of incidence and to deflect away undesired rays exceeding a pre-determined incidence angle by means of a total internal reflection, so as to impart a desired angular selectivity upon the retro-reflector;
wherein the gap has a wedge shape with a vertex angle selected to spatially separate light passing through the gap without reflections therein from light experiencing such reflections in the gap, and wherein the light beam acquires a first angular chromatic dispersion after propagating through the gap;
wherein the second prism has a first reflecting face that is oriented to direct the light beam impinging thereupon from an input face towards the output face thereof;
and wherein orientation of at least one of: the input face of the first prism, the output face of the second prism, and the reflecting face of the second prism with respect to an optical axis of the light beam is selected for imparting on the light beam, upon passing through the output surface of the second prism or the input surface of the first prism, a second angular chromatic dispersion that is opposite to the first chromatic dispersion for at least partial compensation thereof.
